(19) United States
(12) Patent Application Publication
(10) Pub. No.: US 2018/0046997 A1
(43) Pub. Date: Feb. 15, 2018

(54) Peer-to-Peer Food Service

(71) Applicant: IChef, Inc., City of Industry, CA (US)

(72) Inventors: Yu ZHENG, City of Industry, CA (US); Xiaodong ZHANG, City of Industry, CA (US)

(73) Assignee: IChef, Inc., City of Industry, CA (US)

(21) Appl. No.: 15/233,503

(22) Filed: Aug. 10, 2016

(51) Int. Cl. G06Q 20/10

(52) U.S. Cl. CPC G06Q 20/102; G06Q 50/12

(57) ABSTRACT

A system for facilitating peer-to-peer provision of food services includes a plurality of home chefs who are human beings, each having a home chef interface device, a plurality of consumers who are human beings, each having a consumer interface device, and at least two of the following four modules: (i) an order cooked food module through which a consumer orders cooked food from a home chef for immediate consumption, (ii) an order food for event module through which a consumer orders cooked food from a home chef for an event, (iii) an order ingredients module through which a consumer orders ingredients from a home chef, and (iv) an order packed food module through which a consumer orders packaged food items from a home chef.

### BACKGROUND OF THE INVENTION

### 1. Field of the Invention

The present invention relates to a food-providing and food-ordering system and method that connects peers to fellow peers, where a peer can be both a food provider and a food consumer.

### 2. Description of the Prior Art

Eating and dining trends have changed significantly over recent years. As people become busier, they have less time to cook their own meals, much less time to purchase ingredients for cooking. In addition to this trend, there has also been a trend towards healthy eating. Many restaurants have tried to market and promote healthy meals, but regardless of this attempt, meals at restaurants or take-out meals are going to be inherently less healthy than home-cooked meals.

There is also a question of dining choices. In large cities like New York or Chicago, there are probably numerous options for restaurant. However, in the suburbs, where many people live, there are fewer dining choices as the prevailing choices are the national chain restaurants together with a sprinkling of individual or local restaurants. For example, many people would like to have a greater variety in their pizza choices than the local pizzeria, or more Chinese options than the local Chinese fast food joint. To preserve the freshness of the dishes, most meal delivery services are best utilized within a certain geographic proximity, and even restaurant delivery services will usually not deliver beyond a certain geographic proximity.

In the midst of all these busy consumers and dining options, there are still many people who cook their own meals at home (“home chefs”). Of these home chefs, many still cook recipes that have been handed down through the generations, such as that special Southern meatloaf from grandma, that unique pasta dish with ancestral roots from Italy, and that pork dish with the amazing sauce from the heart of China. In addition, these individualized recipes are unique in that no one else makes the same dish with the same flavors. For example, most people have probably tasted sweet and sour pork at restaurants, and fast food places, but grandma's special ancient recipe will often have a unique flavor and taste from any other sweet and sour pork that any restaurant or retail dining establishment can offer. These home chefs often cook these dishes for family, but no one else has the privilege or opportunity to taste these amazing dishes.

Many of these home chefs have often dreamed of sharing their special recipes with others, but opening a restaurant is often not feasible because of the investment, the risks, the costs, and the administrative hassles (e.g., payroll, food permits, taxes, etc.) involved. So they often share their special dishes with friends and neighbors, or with their church or other social groups.

But these special dishes are not limited to a hot food dish. For example, the sweet and sour pork mentioned above might feature a unique sweet and sour sauce which more adventurous diners may want to try with other types of meats (e.g., fish). The home chef who has perfected that dish might want to share that sauce with others, but again suffers from constraints. For example, seeking a factory or other producing facility to make and bottle the sauce in large quantities would again require more investment, risk-taking and cost than the home chef may desire to undertake.

The above scenarios highlight two sectors of the market that have separate needs that have not yet been adequately met. The busy consumer who seeks healthier food with a greater number of food choices is often limited by geography. The home chef who aspires to share his or her special recipe(s) with a wider range of people is limited by the social range of that home chef.

### SUMMARY OF THE DISCLOSURE

The present invention seeks to address the needs of the two sectors of the dining market described above. Specifically, the present invention provides a system and method that brings the busy consumers together with the home chefs to facilitate a peer-to-peer interaction or transaction. Here, “peer” means an individual or human being which is not a retail, wholesale or other business entity, but who can be both a consumer and a home chef. As used herein, “peer” does not include any non-human entity, and must be a human being. For example, the busy consumer can also be a home chef offering a limited menu of a couple of special dishes which he or she has expertise in cooking. Similarly, the home chef can also be a consumer who is unable to cook on certain days and desires to order food or ingredients from another home chef.

In order to accomplish the objects of the present invention, there is provided a system for facilitating peer-to-peer provision of food services. The system includes a plurality of home chefs who are human beings, each having a home chef interface device, a plurality of consumers who are human beings, each having a consumer interface device, and at least two of the following four modules: (i) an order cooked food module through which a consumer orders cooked food from a home chef for immediate consumption, (ii) an order food for event module through which a consumer orders cooked food from a home chef for an event, (iii) an order ingredients module through which a consumer orders ingredients from a home chef, and (iv) an order packed food module through which a consumer orders packaged food items from a home chef.

### BRIEF DESCRIPTION OF THE DRAWINGS

FIG. 1 illustrates a peer-to-peer system according to one embodiment of the present invention.

FIG. 2 is a general flowchart illustrating the operation of the system of FIG. 1.

FIG. 3 is a schematic diagram illustrating the hardware components of the server of FIG. 1.

FIG. 4 is a flowchart illustrating the food services option in FIG. 2.

FIG. 5 is a flowchart illustrating the Order Cooked Food option in FIG. 4.

FIGS. 6-9 are various possible screenshots for various steps in the Order Cooked Food option of FIG. 5.

FIG. 10 is a flowchart illustrating the Order Food for Event option in FIG. 4.

FIG. 11 is a flowchart illustrating the Order Ingredients option in FIG. 4.

FIGS. 12-13 are various possible screenshots for various steps in the Order Ingredients option of FIG. 11.

FIG. 14 is a flowchart illustrating the Order Packed Food option in FIG. 4.

FIG. 15 is a flowchart illustrating the chef database option in FIG. 2.

FIG. 16 is a flowchart illustrating the Order Cooked Food option in FIG. 15

FIGS. 17-21 are various possible screenshots for chef database option of FIG. 2.

FIG. 22 is a flowchart illustrating the Order Food for Event option in FIG. 15.

FIG. 23 is a possible screenshot for one of the events in the Order Food for Event option of FIG. 22.

FIG. 24 is a flowchart illustrating the Order Ingredients option in FIG. 15.

FIG. 25 is a possible screenshot for the cooking instructions in the Order Ingredients option of FIG. 24.

FIG. 26 is a flowchart illustrating the Order Packed Food option in FIG. 15.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

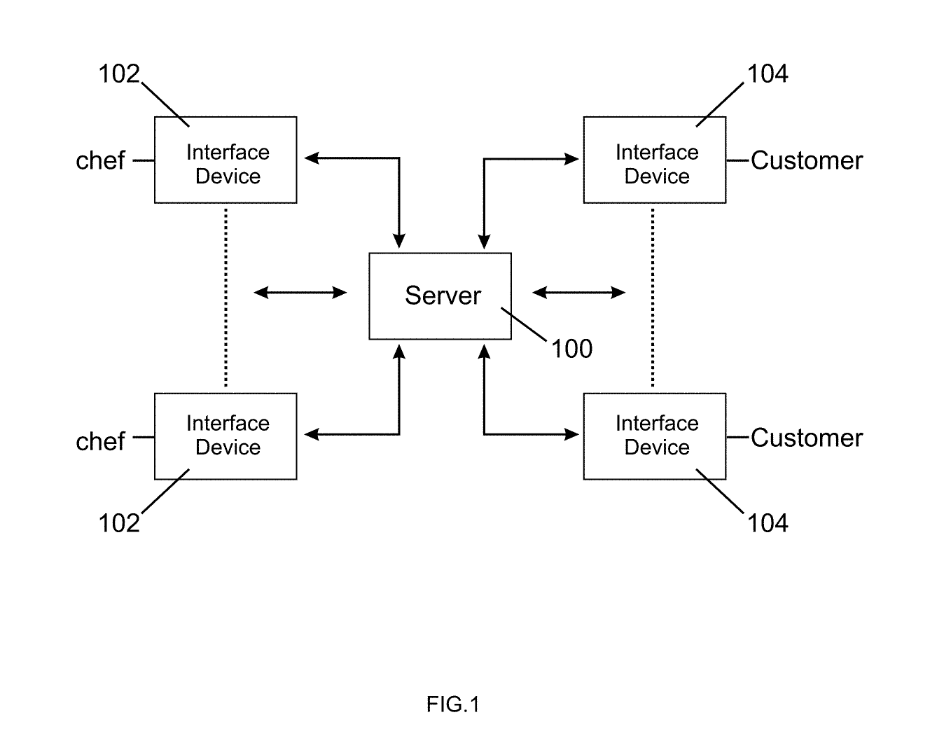

FIG. 1 illustrates the general components of a peer-to-peer system according to the present invention. The system includes a server 100 that communicates with a plurality of chef interface devices 102 and a plurality of consumer interface devices 104. Each of these interface devices 102 and 104 can be a laptop computer, a desktop computer, a tablet, a smartphone, or any other computing device. Each of the chef interface devices 102 can be associated with a home chef for use by that chef in processing food and/or ingredient orders as described below. Each of the consumer interface devices 104 can be associated with a consumer for use by that consumer in ordering food and/or ingredient, and in arranging delivery of the orders, as described below. In addition, a home chef can be a consumer, and vice versa.

The server 100 communicates with the interface devices 102 and 104 via conventional cellular, wireless, wired and other known communication means.

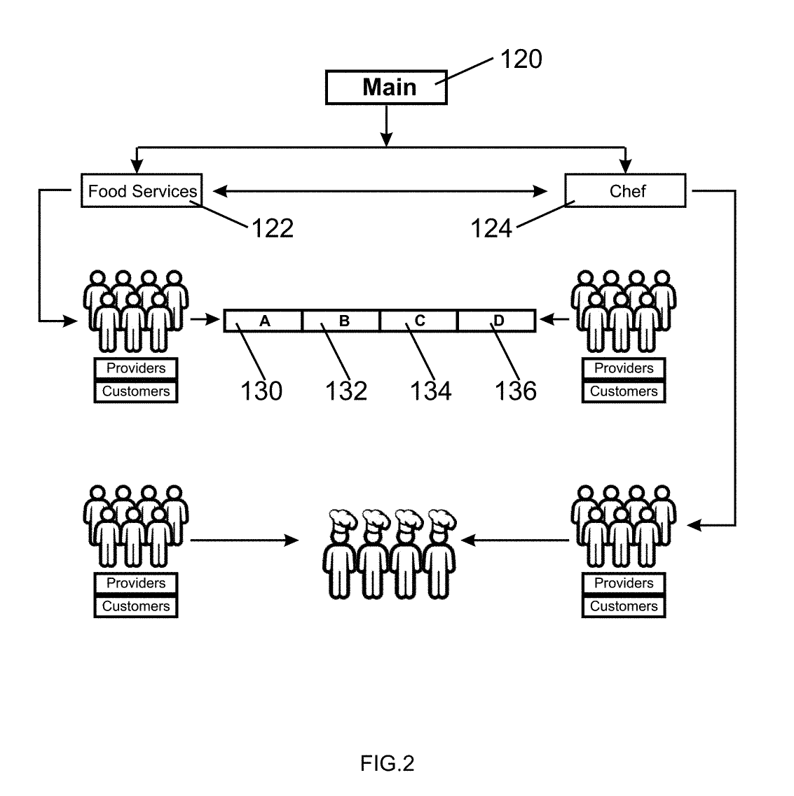

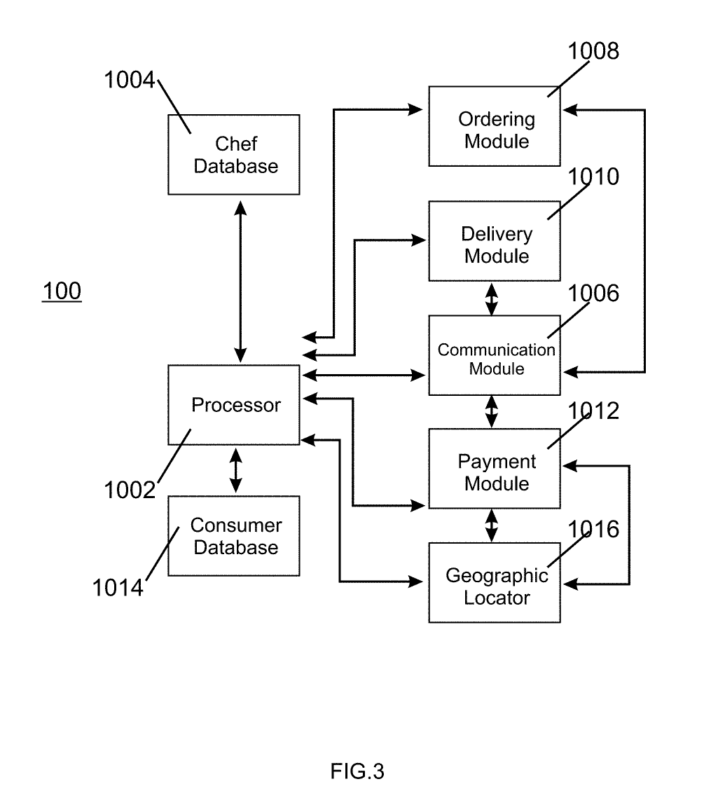

FIG. 2 is a general flow diagram illustrating the operation of the peer-to-peer system of the present invention. When a consumer or home chef logs in to the system, he or she would reach the “Main” page 120 where the user is prompted to select one of two modules or choices: Food Services 122 and Chef Database 124. The Food Services 122 module is the selection for a consumer desiring to order food, order ingredients, or attend an event, and is described in greater detail below. The Chef Database 124 module is the selection for a consumer desiring to search the chef database 1004 (see FIG. 3) to locate a desired chef, or to search for the home chefs who cook certain types of food or dishes, etc., and is described in greater detail below.

1. Food Services 122

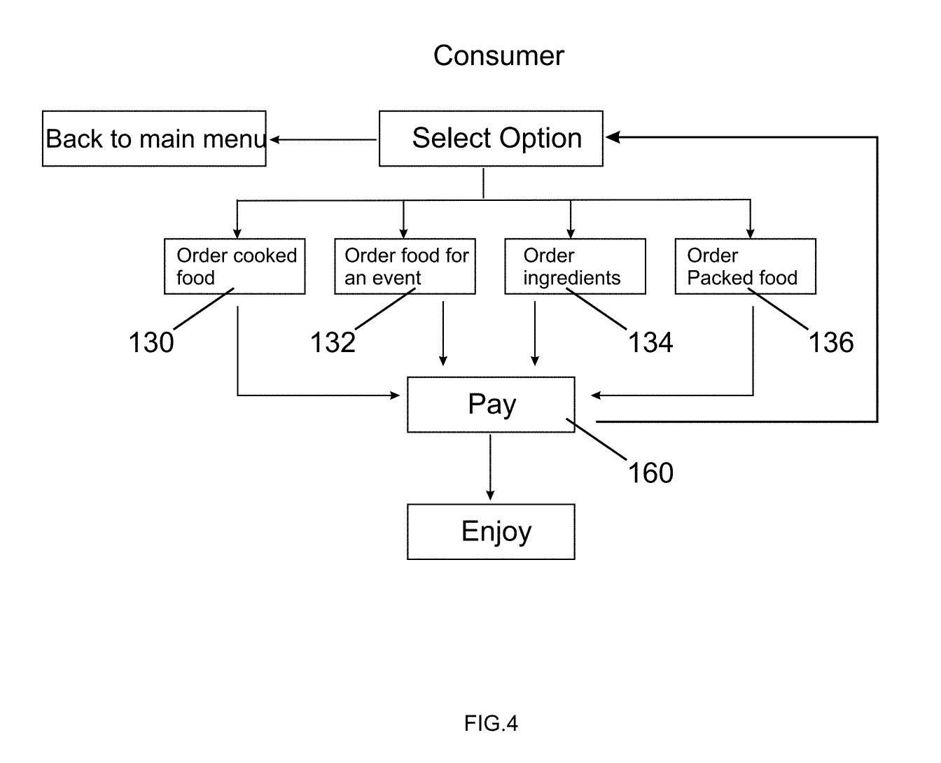

The Food Services 122 module is illustrated in greater detail in FIGS. 4-14. First, as shown in FIG. 2, the home chefs can be consumers, and the consumers can also be home chefs. Referring now to FIG. 4, the user can select one of four different modules or options: order cooked food 130, order food for an event 132, order ingredients 134, and order packed food 136.

Order Cooked Food 130

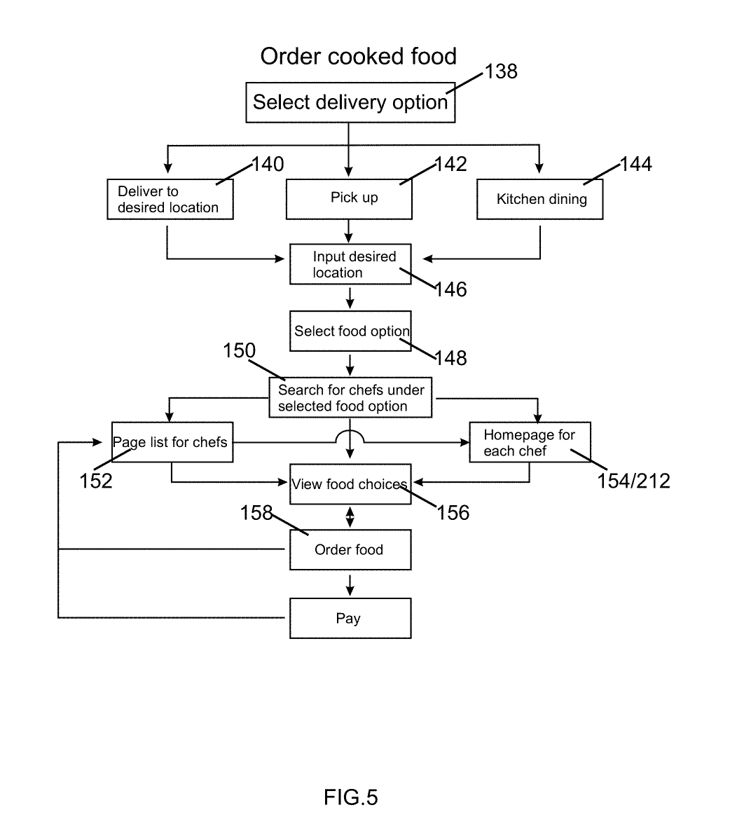

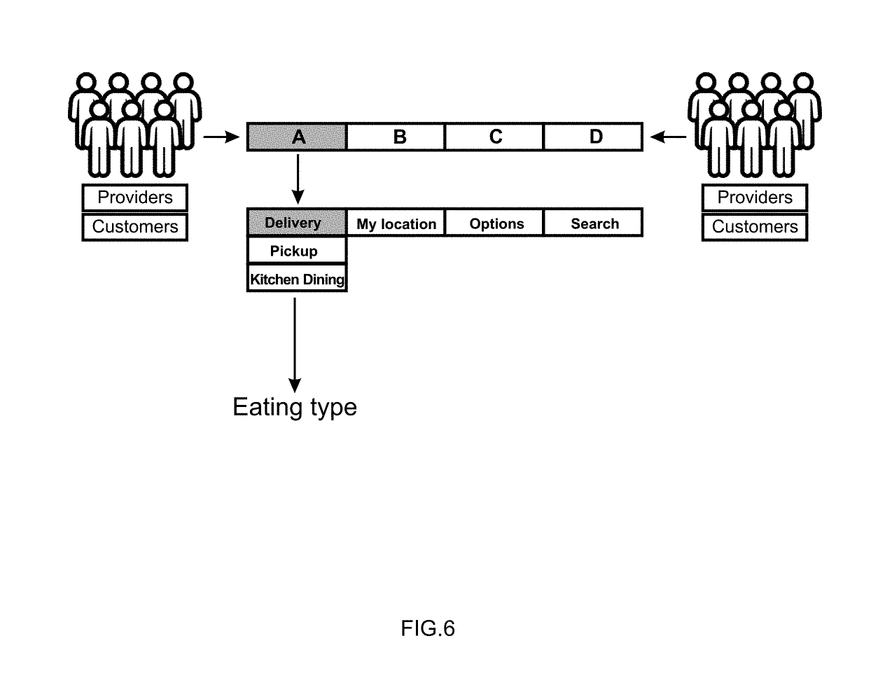

FIG. 5 illustrates the steps for order cooked food 130. Under this module or option, the consumer can order cooked food for immediate pickup or delivery. The first step is to select the delivery option 138. FIG. 6 illustrates a possible screenshot for the three delivery options: delivery to a desired location 140, pick-up 142 and kitchen dining 144. Kitchen dining 144 is an option that can be offered by a home chef, where a consumer can dine at the home of the home chef. Often, the home chef has prepared enough food for a sitting at a specific time, and can accommodate up to a specific number (e.g., ten) of diners who come to his or her house and dine with all the other guests. It is possible that none of the guests know each other, so this would be a great option to meet other people and socialize. It is also possible for a consumer to meet a friend or relative at the home of the home chef to dine on the dishes selected by the consumers. Thus, the kitchen dining 144 option provides consumers with another location to eat, instead of simply eating at home. This option could be especially useful for consumers who are actually in a different city or geographic area and is either desirous of trying new foods, or is interested in setting up a meeting with a friend or relative.

After the consumer selects the delivery option, the next step is to input the consumer's location 146. This location can be the location where the home chef is located, or where the consumer is located, and this information is utilized by the system to limit its search for home chefs within a reasonable geographic boundary. However, the consumer is not limited solely to home chefs at his or her current location. The consumer could be in one city but input the zip code or city name of a different city to search for dining and food options in the other city.

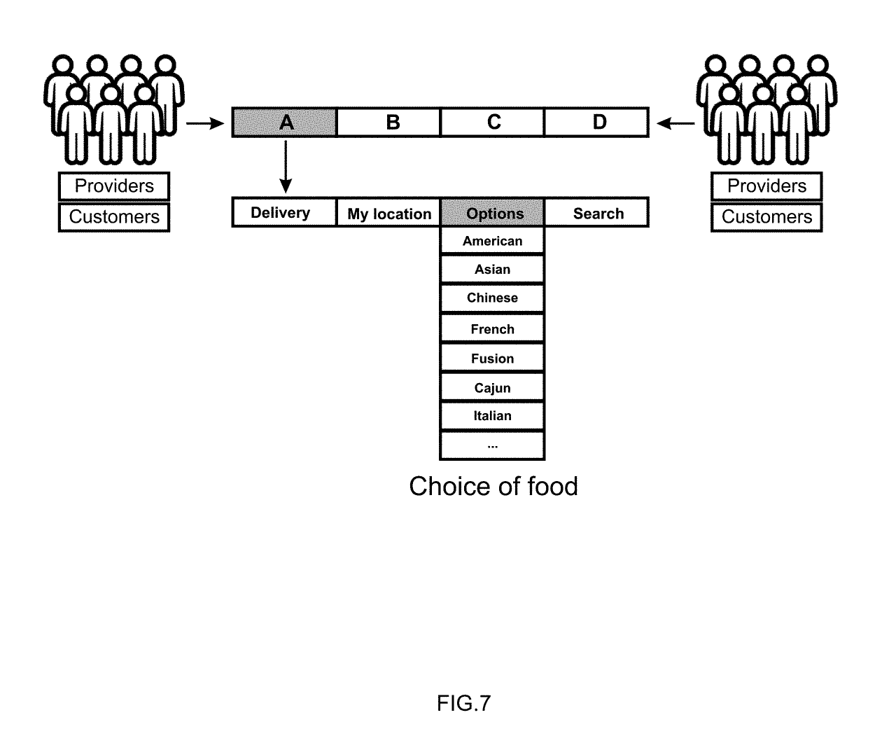

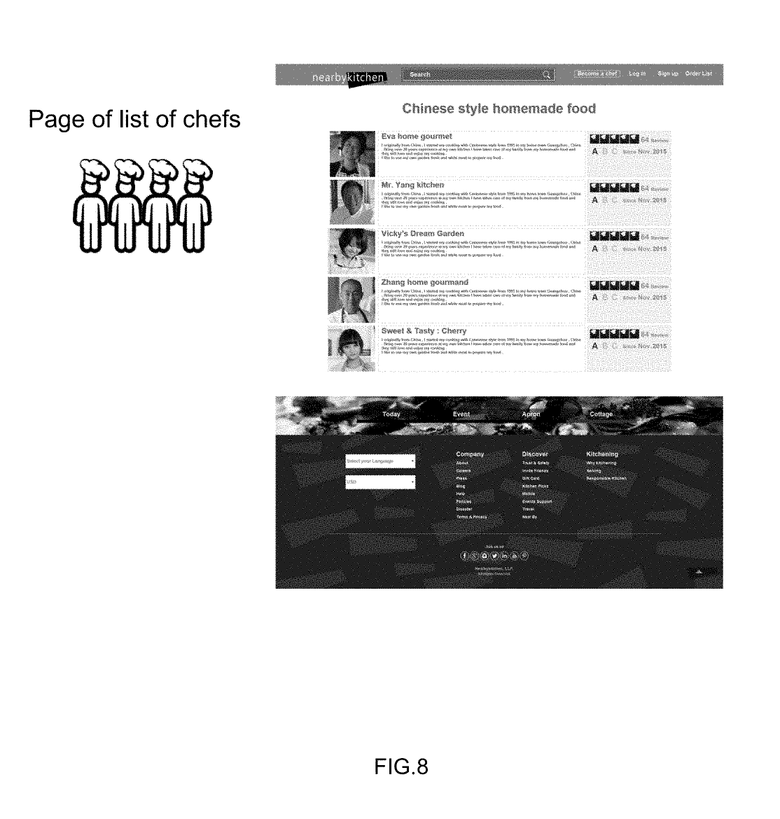

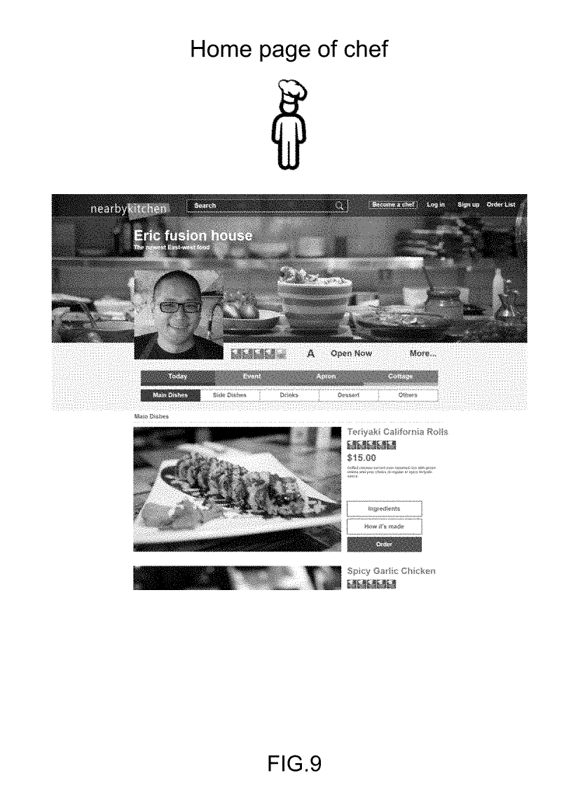

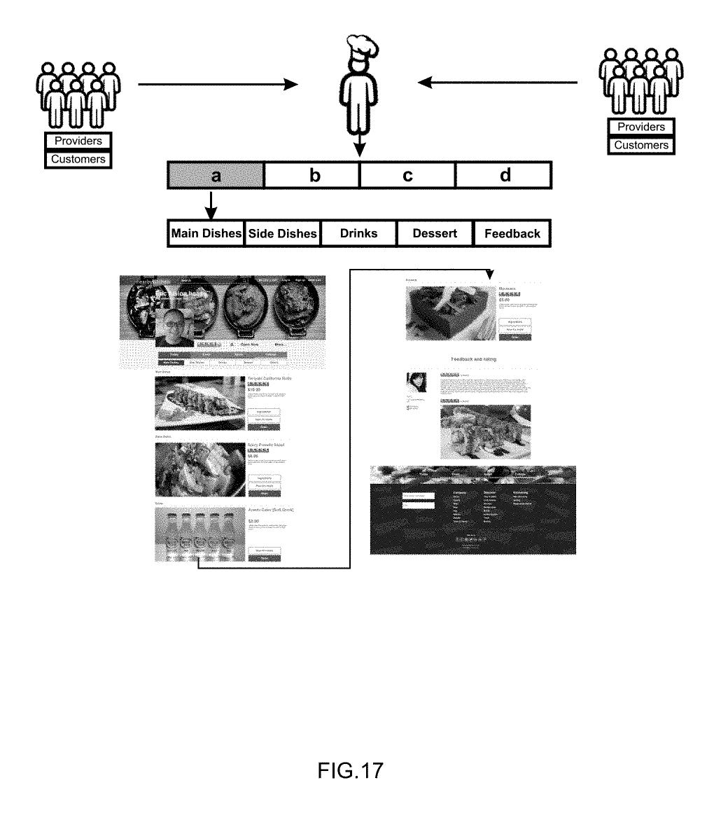

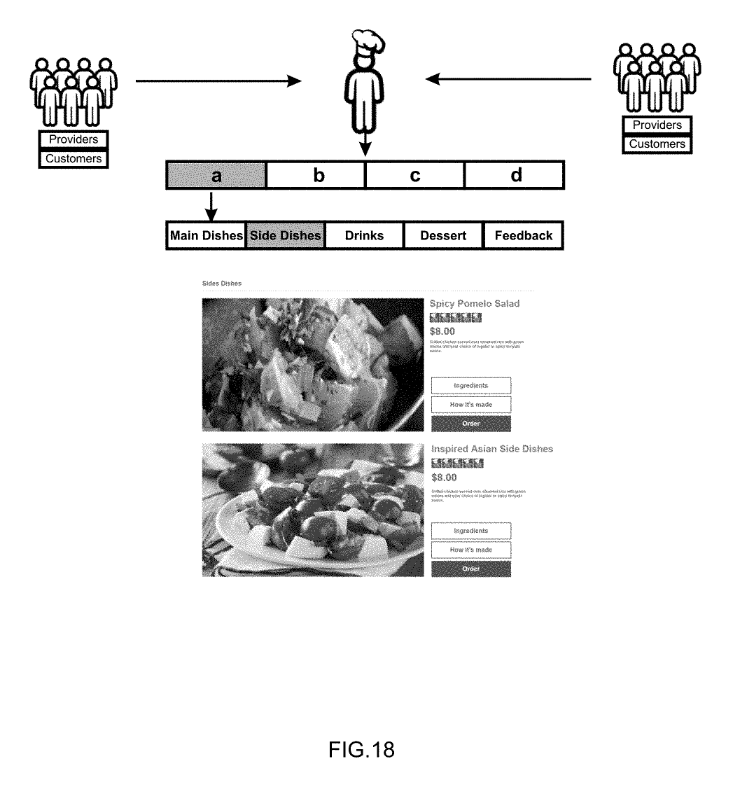

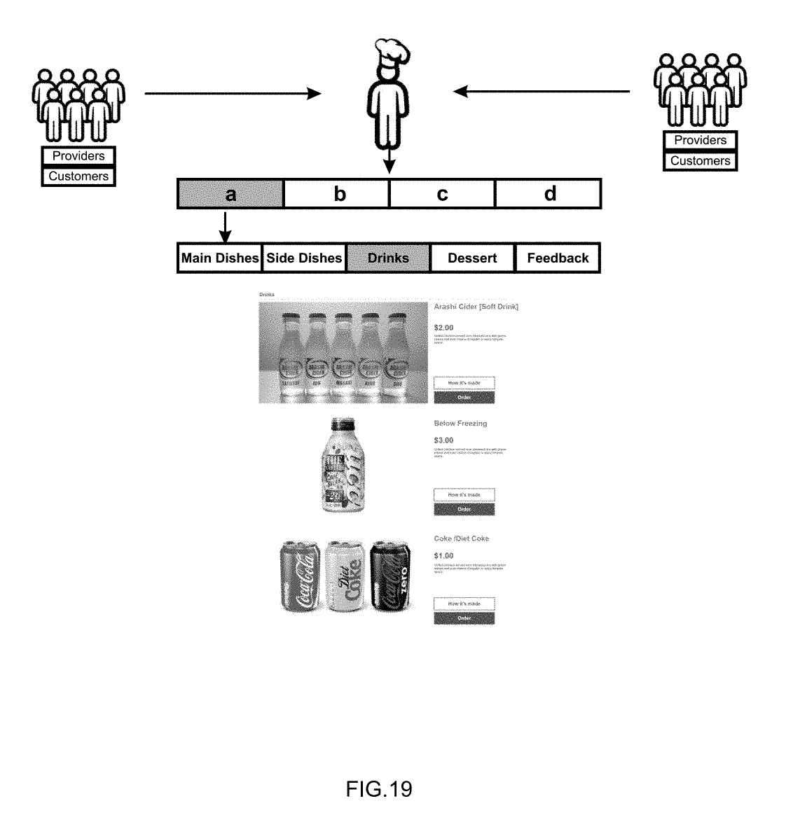

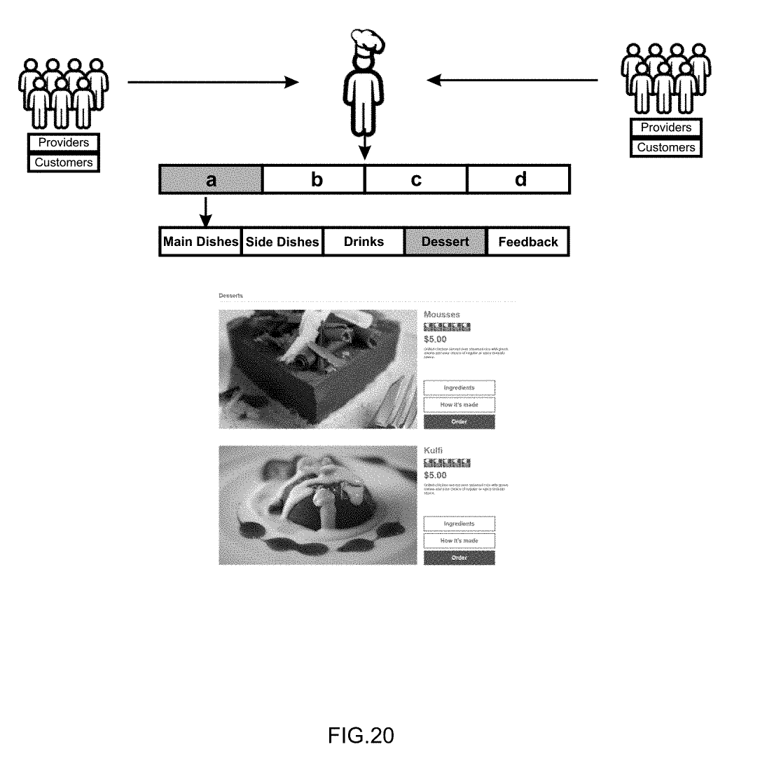

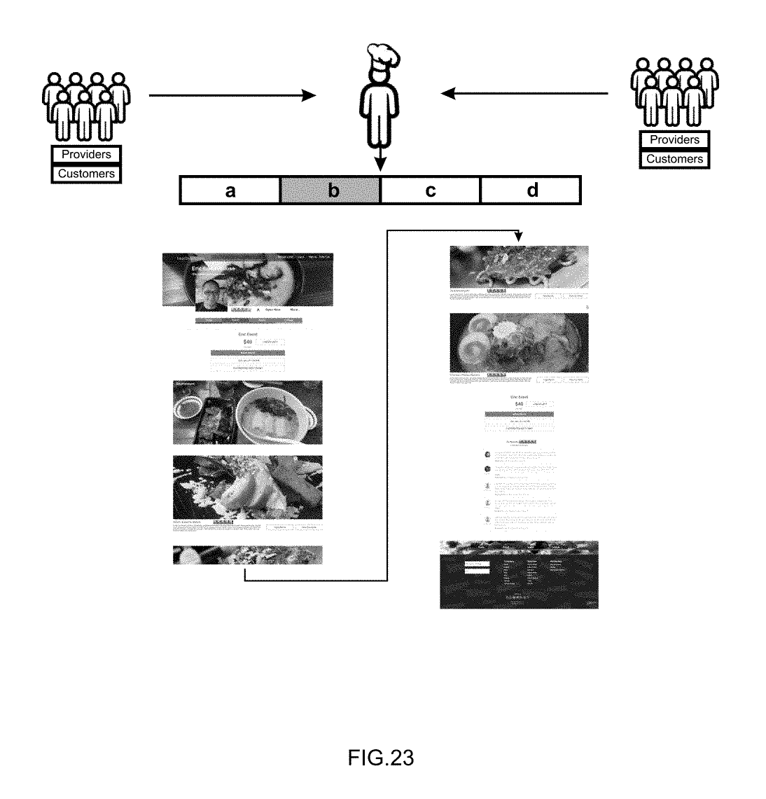

Next, the consumer selects the food option 148, which is usually the type of food. FIG. 7 illustrates a possible screenshot for the various options. After the consumer selects the food option 148, the consumer can search for one or more home chefs 150 under the selected food option. The search 150 provides the user with three further searching options: a page list 152, a link to home pages of home chefs 154, and a listing of food choices or menu items 156. FIG. 8 is a possible screenshot for a page listing of the various home chefs offering Chinese food, and FIG. 9 is a possible screenshot for the home page of a home chef. The home pages (FIG. 9) can be accessed directly from step 150, or from the page list 152, or from the food choices 156. The home pages for the selected chef can be browsed in the manner described below in connection with FIGS. 17-21, 23 and 25.

Next, the consumer can view the various menu items 156 from the selected home chef, and then select a menu item 158. At this point, the consumer can proceed to checkout, or return to step 148 to order another item. It should be noted that the consumer can order different items from different home chefs, or all items from the same home chef. However, all orders with one home chef must be concluded before the user can place orders with a different home chef.

Once the consumer has completed ordering food items, he or she can proceed to checkout in step 160 (see FIG. 4), and then enjoy the food after the food has been delivered or picked up. If the consumer selected the kitchen dining 144 option, the consumer would have to show up at the home chefs home or designated location to eat. If the consumer ordered food under the kitchen dining 144 option from more than one home chef, then the consumer must schedule the kitchen visits at different times.

Order Food for an Event 132

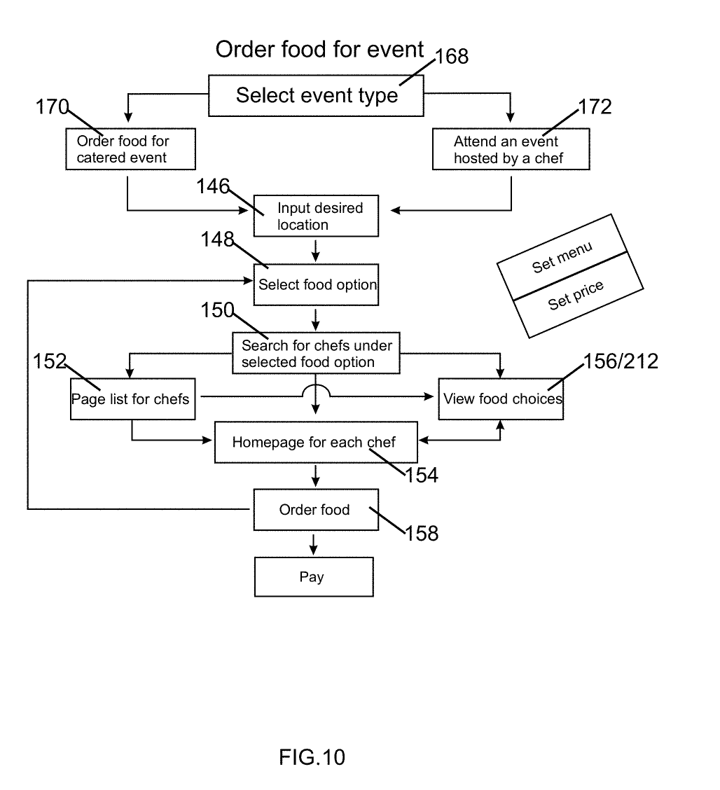

FIG. 10 illustrates the steps for order food for an event 132. Under this module or option, the consumer has to select 168 one of two events: (i) the consumer can order cooked food for a catered event 170, or (ii) the consumer can attend an event hosted by a home chef 172. The catered event in step 170 can be an event that the consumer is holding at his or her home, at an office, or other social location or setting. The event hosted by the home chef in step 172 can be similar to the kitchen dining 144 option, but differs in that this event could be a larger event (i.e., more than a few people sharing a table at a home chefs house) hosted by the home chef, such as an event at a public location intended to showcase the home chefs cooking and food, or a special cultural, sporting, social or political event (e.g., Chinese New Year, youth basketball tournament, fundraising, etc.) where the home chef is participating in.

After the consumer selects the event type, the next step is to input the consumer's location 146. This step 146, and the remaining steps 148, 150, 152, 154, 156, 158 and 160, can be the same as for the Order Cooked Food 130 option shown in FIG. 5, and will not be repeated herein.

If the event is hosted by the home chef, then the consumer who purchases one or more tickets/items can simply show up at the designated location and eat there. If the event is to be catered at a location chosen by the consumer, then the home chef and the consumer are put in contact with each other (e.g., via automated texts or emails) so that they can arrange for the details of the delivery of the food to the catered event.

Order Ingredients 134

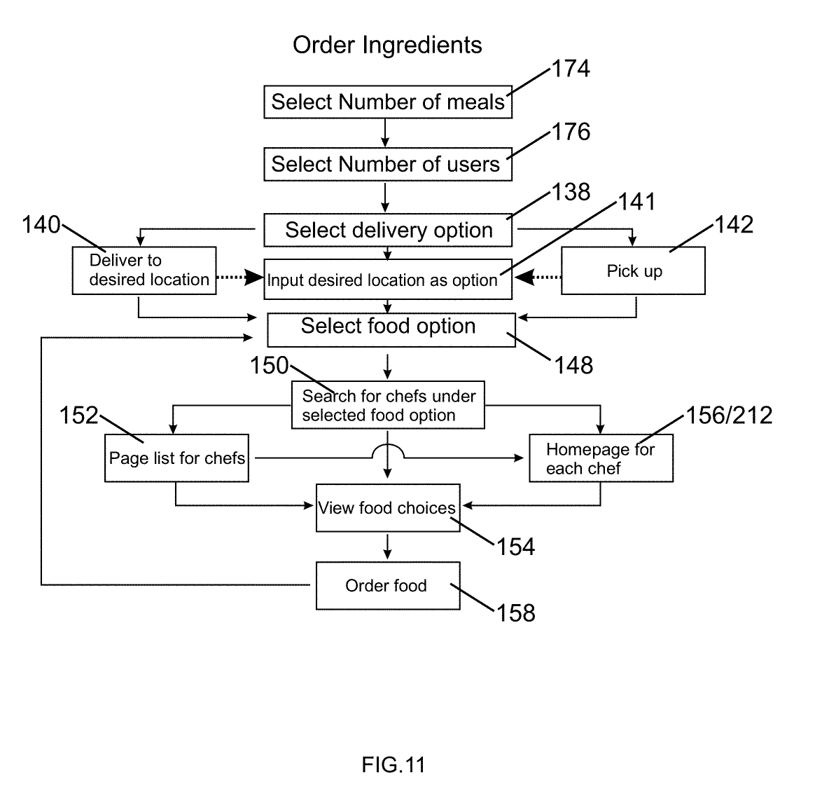

FIG. 11 illustrates the steps for order ingredients 134. A consumer might enjoy cooking and might have the time to cook a meal. In addition, a consumer might have tried a dish from a home chef, enjoyed it, and now wants to cook it at home on a regular basis. The order ingredients 134 module or option therefore provides a consumer with the ingredients for cooking a dish.

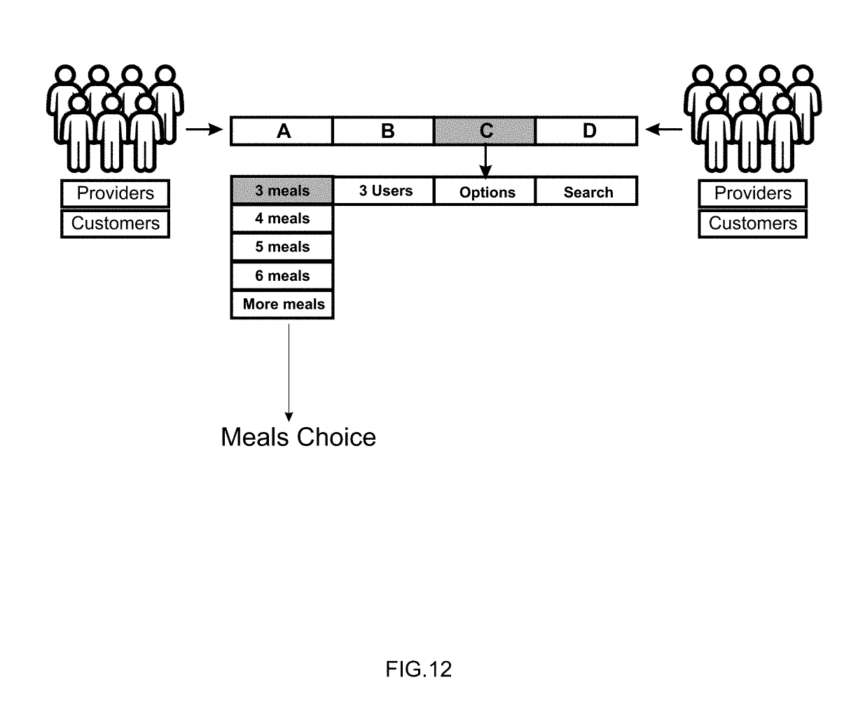

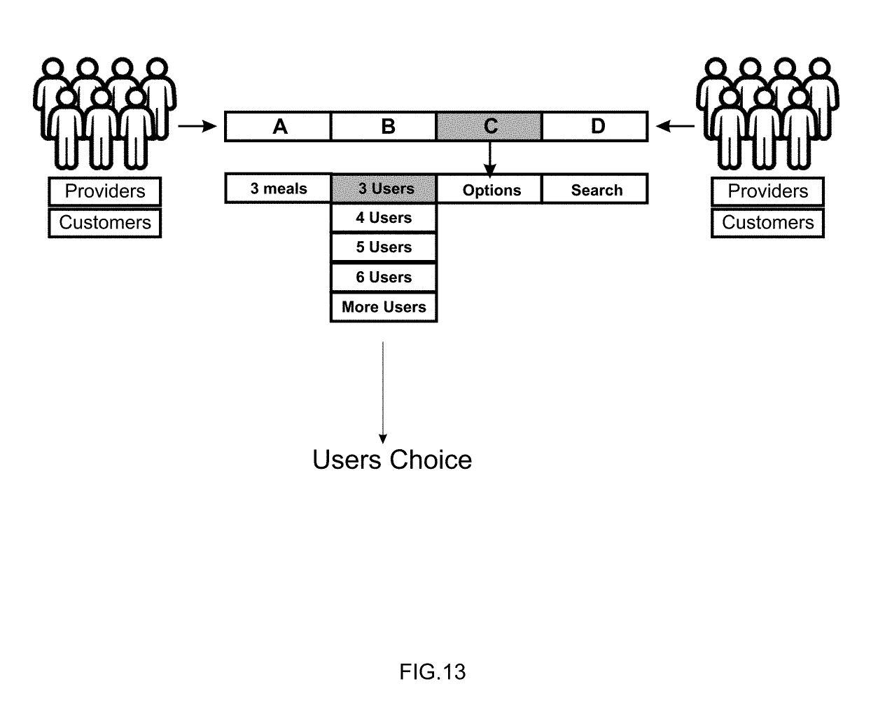

Under this option, the consumer first has to select the number of meals 174 and the number of users (diners) 176. Possible screenshots for these two steps 174 and 176 are shown in FIGS. 12 and 13, respectively. The consumer then has to select the delivery option 138, which can be the same as in FIG. 5 for the Order Cooked Food 130 option except that the consumer's subsequent selections are limited only to delivery to a desired location 140, and pick-up 142, as kitchen dining 144 is no longer applicable here. It is also possible to input a separate or additional desired location (e.g., another friend or relative) that the same ingredients to be delivered to.

After the consumer selects the delivery option 138, the next step is to select the food option 148. This step 148, and the remaining steps 150, 152, 154, 156, 158 and 160, can be the same as for the Order Cooked Food 130 option shown in FIG. 5, and will not be repeated herein.

Order Packed Food 136

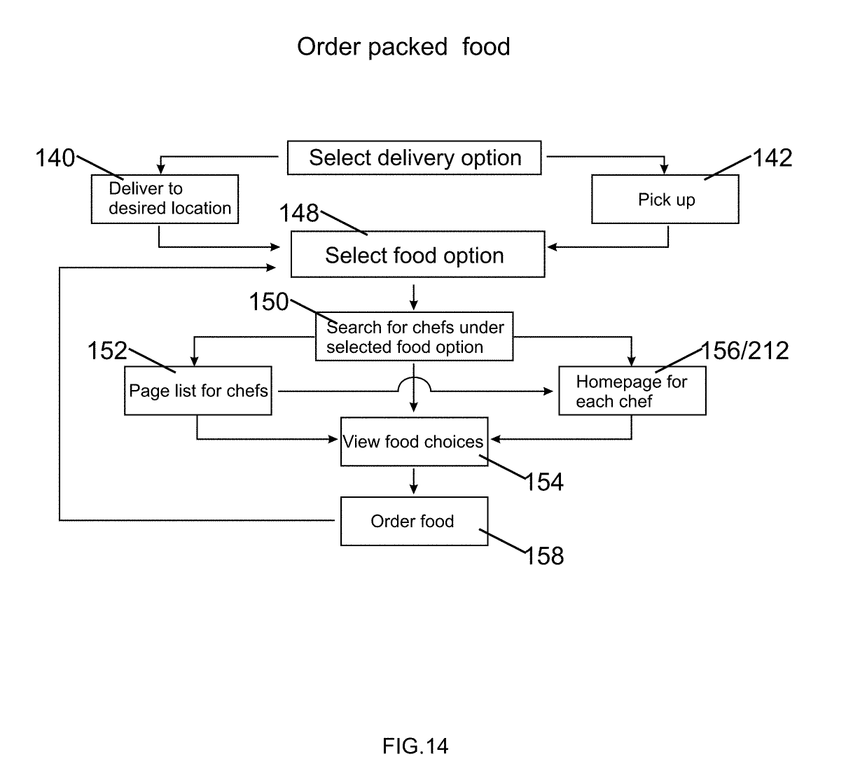

FIG. 14 illustrates the steps for order packed food option 136. This module or option allows a consumer to purchase prepared food items that are not necessarily a complete dish or a meal in itself. Examples of food items that are purchased under this option 136 include pre-packaged sauces, condiments, snacks, cake, bread, preserved meats (e.g., sausages) and related food items, such as preserved fruit, olive oil, and croutons. The packed food option 136 differs from the ingredients 134 in that the packed food items in this option 136 are usually edible without further cooking or processing, whereas the ingredients that are purchased with the ingredients option 134 are usually not cooked.

Under this module or option 136, the consumer first has to select the delivery option 138, which can be the same as in FIG. 5 for the Order Cooked Food 130 option except that the consumer's subsequent selections are limited only to delivery to a desired location 140, and pick-up 142, as kitchen dining 144 is no longer applicable here.

After the consumer selects the delivery option 138, the next step is to select the food option 148. This step 148, and the remaining steps 150, 152, 154, 156, 158 and 160, can be the same as for the Order Cooked Food 130 option shown in FIG. 5, and will not be repeated herein. The only difference is that the quantity or volume of the packed food item is specified in one of these steps, and the user is allowed to select the quantity or volume. Since different packed food items can be sold in different packagings (e.g., bottles, bags, containers, etc.), these quantity or volume selections will vary depending on the item being ordered.

2. Chef Database 124

The chef database 124 module or option allows a consumer to search the chef database 1004 (see FIG. 3) to locate a desired chef, or to search for the home chefs who cook certain types of food or dishes. This can be done prior to ordering food under Food Services 122.

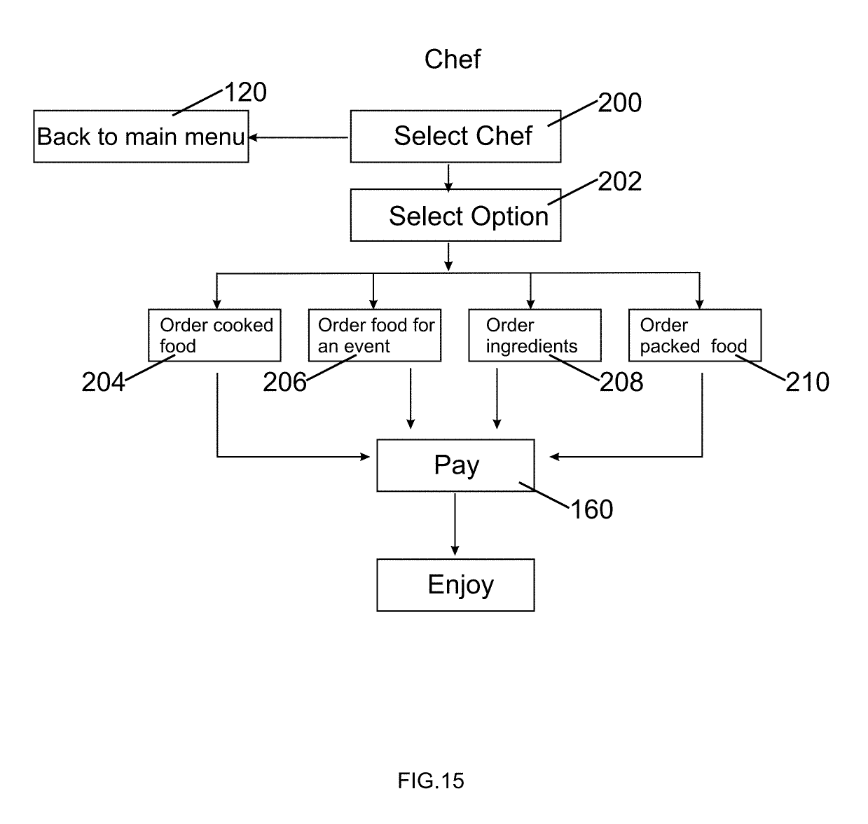

The Chef Database 124 option is illustrated in greater detail in FIGS. 15-26. First, as shown in FIG. 2, the home chefs can be consumers, and the consumers can also be home chefs. Referring now to FIG. 15, the consumer first selects a chef 200 from the database 1004. The search can be conducted based on any number of search criteria, ranging from geographic location, type of cuisine, and reviews, among others. Once a chef has been selected, the consumer can then select one of four different options 202: order cooked food 204, order food for an event 206, order ingredients 208, and order packed food 210.

Order Cooked Food 204

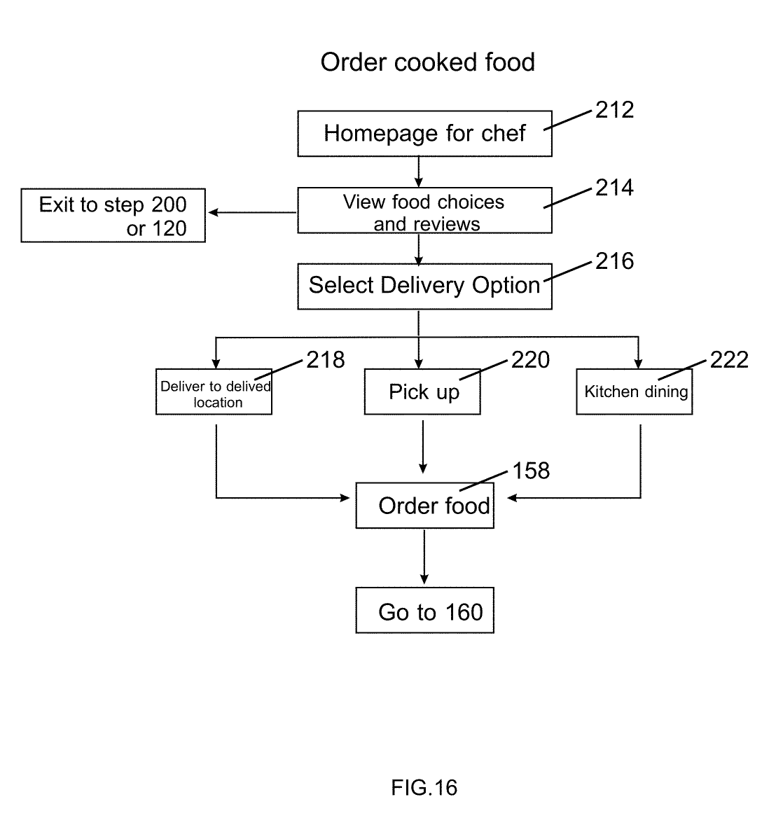

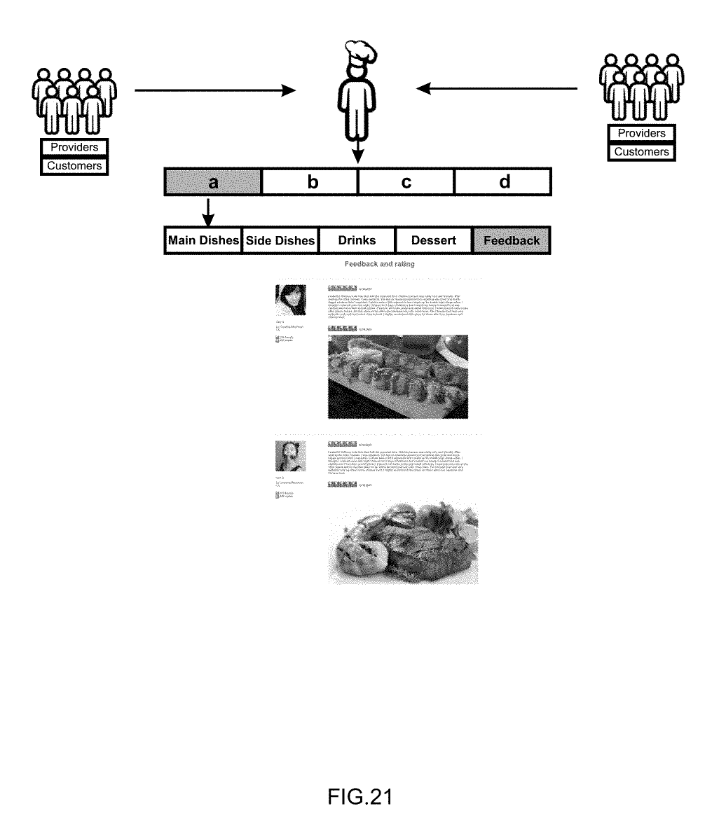

FIG. 16 illustrates the steps for ordering cooked food 204. Under this option, the consumer can order cooked food for immediate pickup or delivery from the chef selected at step 200. At this point, the consumer is in the home page of the selected chef 212. The first step is to view the food choices and reviews 214, FIGS. 17-21 are possible screenshots when the consumer clicks on the links for “main dishes”, ‘side dishes”, “drinks”, “desserts”, and “feedback”, respectively, on the home page for the selected chef. As can be seen from FIGS. 17-21, the various menu items are displayed with their prices, together with accompanying photographs, ratings, and some basic information (e.g., brief description of the dish), and with links to other information such as nutritional information, how the dish is made, etc. A link is also provided for ordering the dish or item. FIG. 21 also illustrates a possible screenshot if the consumer clicks on the “feedback” link, which displays reviews and other feedback from other consumers regarding that particular chef. The reviews can include reviews about a dish, or about the chef, or both.

If the consumer does not want to order anything from this chef, the consumer can exit to step 200 (i.e., select a new chef in FIG. 15). Otherwise, if the consumer wishes to order a food item from this chef, the consumer can select the items (which can be more than one item) that he/she wishes to order, and then proceeds to select the delivery option 216, which can be the same three delivery options for Order Cooked Food 130 above: delivery to a desired location 218, pick-up 220 and kitchen dining 222. After selecting the desired delivery option, processing takes the consumer to checkout (see step 160 in FIG. 4).

Order Food for an Event 206

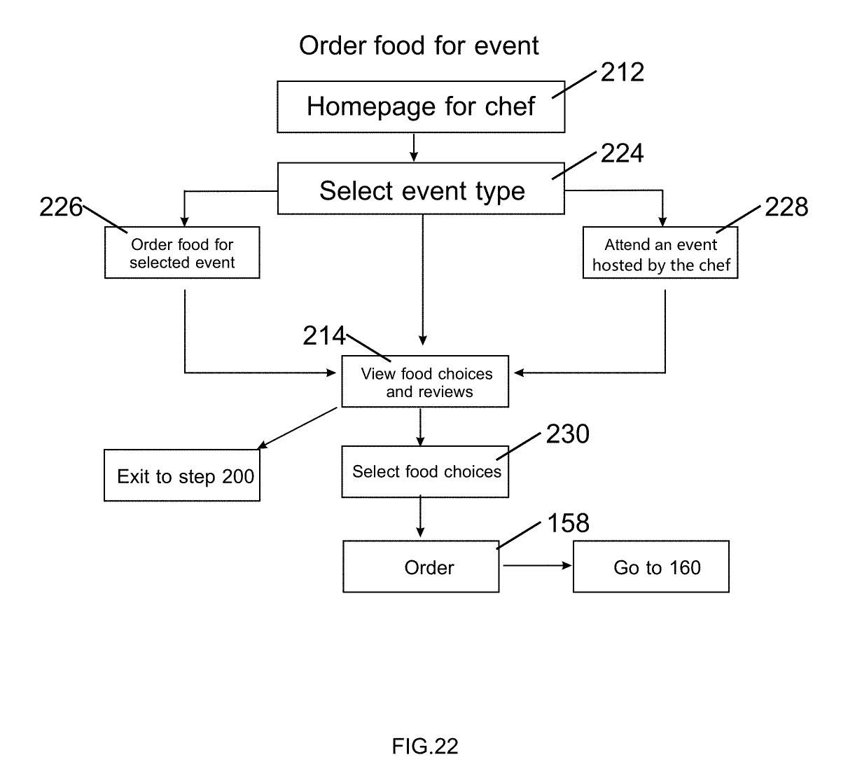

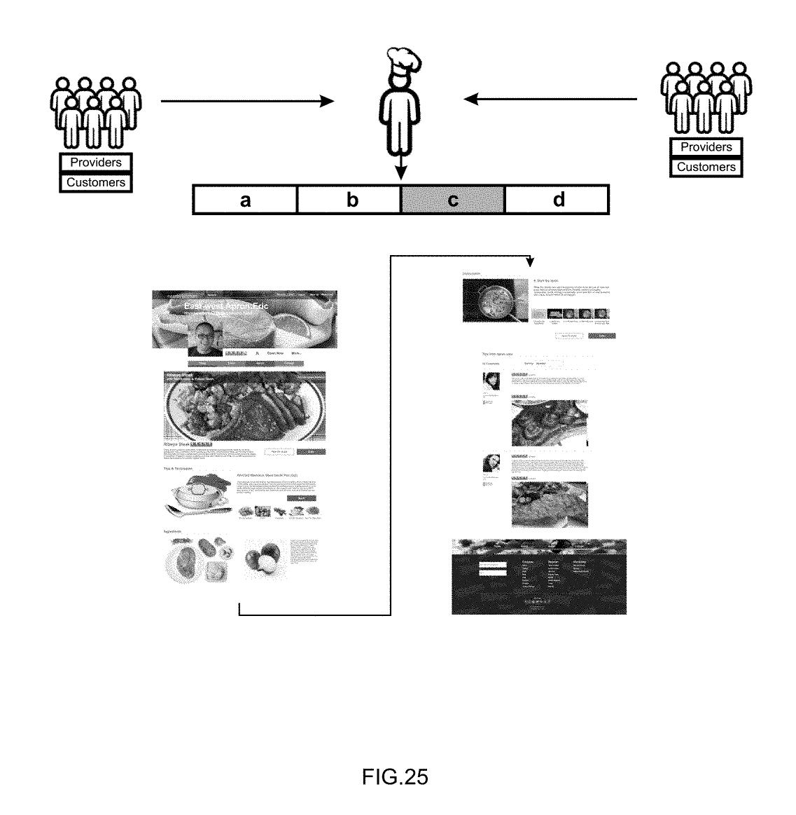

FIG. 22 illustrates the steps for ordering food for an event 206. Under this option, the consumer can order cooked food for a catered event 226 or attend an event hosted by the chef 228 selected at step 200. This is similar to the Order Food for an Event 132 (see FIG. 10). At this point, the consumer is in the home page of the selected chef 212. The first step is to select the type of event 224, which can be either to order cooked food for a catered event 226 or to attend an event hosted by the chef 228. After the type of event has been selected, the consumer can view the food choices and reviews 214, which is the same as in step 214 of FIG. 16. Again, FIGS. 17-21 are possible screenshots when the consumer clicks on the links for “main dishes”, ‘side dishes”, “drinks”, “desserts”, and “feedback”, respectively, on the home page for the selected chef. Here, there is an additional page (see screenshot of FIG. 25) which shows a fixed ticket price for an event hosted by the chef, where every attendee is served the same dishes/items. This page would show the food items and information related to these items.

If the consumer does not want to order anything from this chef, the consumer can exit to step 200 (i.e., select a new chef in FIG. 15). Otherwise, if the consumer wishes to order a food item from this chef, the consumer can select the items (which can be more than one item) that he/she wishes to order 230. Processing then takes the consumer to checkout (see step 160 in FIG. 4).

Order Ingredients 208

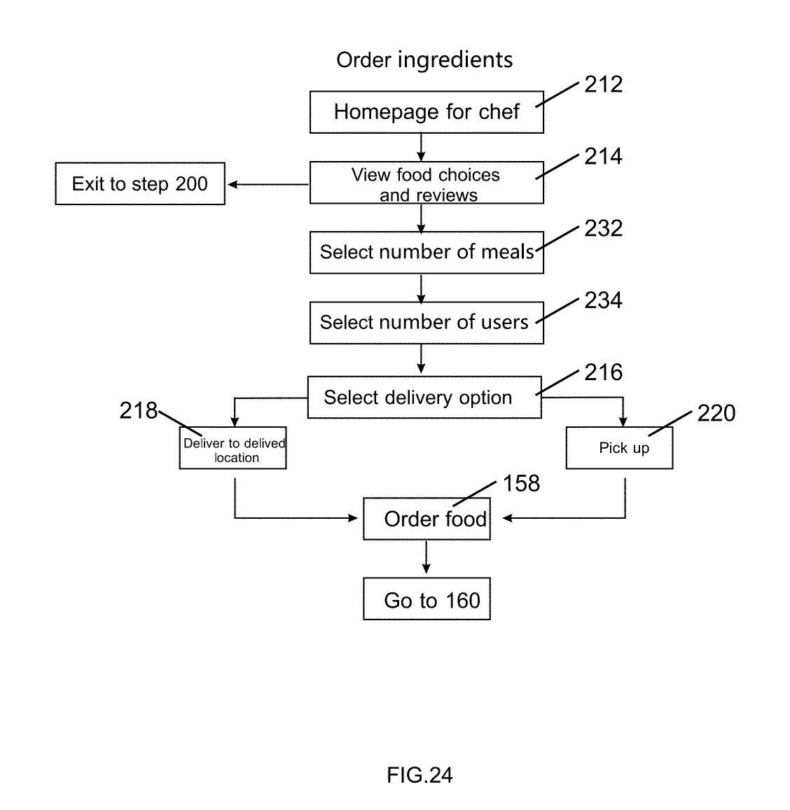

FIG. 24 illustrates the steps for ordering ingredients 208. This option is similar to the Order Ingredients option 134 (see FIG. 11). At this point, the consumer is in the home page of the selected chef 212. The first step is to view the food choices and reviews 214, which can be the same as in FIG. 16. Again, FIGS. 17-21 are possible screenshots when the consumer clicks on the links for “main dishes”, ‘side dishes”, “drinks”, “desserts”, and “feedback”, respectively, on the home page for the selected chef. A enabled link (e.g., via the use of a password) is also provided for instructions on how to cook the dish after the consumer receives the ingredients. FIG. 25 is a possible screenshot for the cooking instructions. These cooking instructions can be provided on a piece of paper with the actual delivery of the ingredients.

If the consumer does not want to order anything from this chef, the consumer can exit to step 200 (i.e., select a new chef in FIG. 15). Otherwise, if the consumer wishes to order ingredients for a food item from this chef, the consumer can select the items (which can be more than one item) that he/she wishes to order. In steps 232 and 234, the consumer must specify the number of meals and the number of diners/users, and then the consumer proceeds to select the delivery option 216: delivery to a desired location 218 or pick-up 220, both of which can be the same as in FIG. 16. After selecting the desired delivery option, processing takes the consumer to checkout (see step 160 in FIG. 4).

Order Packed Food 210

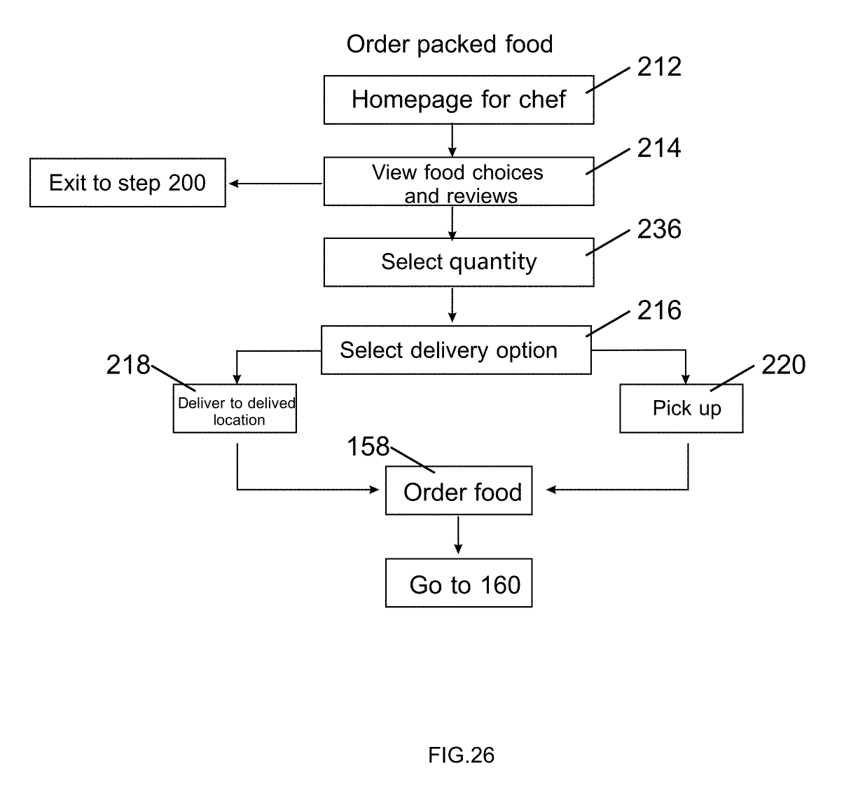

FIG. 26 illustrates the steps for ordering packed food 210. This option is similar to the Order Packed Food option 136 (see FIG. 14). At this point, the consumer is in the home page of the selected chef 212. The first step is to view the food choices and reviews 214, which can be the same as in FIG. 16. Again, FIGS. 17-21 are possible screenshots when the consumer clicks on the links for “main dishes”, ‘side dishes”, “drinks”, “desserts”, and “feedback”, respectively, on the home page for the selected chef.

If the consumer does not want to order anything from this chef, the consumer can exit to step 200 (i.e., select a new chef in FIG. 15). Otherwise, if the consumer wishes to order a food item from this chef, the consumer can select the items (which can be more than one item) that he/she wishes to order. In step 236, the consumer must specify the quantity, and then the consumer proceeds to select the delivery option 216: delivery to a desired location 218 or pick-up 220, both of which can be the same as in FIG. 16. After selecting the desired delivery option, processing takes the consumer to checkout (see step 160 in FIG. 4).

3. Hardware

FIG. 3 illustrates one non-limiting example of the hardware for the server 100. The server 100 can include a processor 1002, a chef database 1004 that contains all the information for all the home chefs, a consumer database 1014 that contains all the information for all the consumers (who can also be home chefs and vice versa), a communication module 1006, an ordering module 1008, a delivery module 1010, a payment module 1012, a consumer database 1014 and a geographic locator 1016.

The communication module 1006 functions to facilitate communication between the server 100 and the interface devices 102 and 104. The communication can be accomplished using known techniques such as cellular data, wireless internet, cloud delivery and others. The communication module 1006 communicates with the processor 1002 and with the ordering module 1008, delivery module 1010, the payment module 1012 and the geographic locator 1016.

The processor 1002 functions to control all the processing activity performed by the communication module 1006, the ordering module 1008, the delivery module 1010, the payment module 1012 and the geographic locator 1016. The processor 1002 communicates with all of these modules 1006, 1008, 1010, 1012, 1016 and with the chef database 1004 and the consumer database 1014.

The chef database 1004 contains all relevant home chef information, including address, health and safety certifications, menu items, prices, reviews and all other information that can be displayed on the home web page of the chef.

The consumer database 1014 contains all relevant consumer information, including names, addresses, preferences, order history, reviews, payment (e.g., credit card) information, phone numbers, delivery history and any other information that can be helpful to the system.

The ordering module 1008 functions to coordinate all the ordering steps that need to be taken to allow the consumer to place orders in step 158.

The delivery module 1010 functions to coordinate delivery between the home chef(s) and the consumer. This includes sending emails, texts and other communication messages between the home chef(s), the consumer and any delivery services who might have to deliver order food items to a destination specified by the consumer.

The payment module 1012 functions to coordinate payment between the consumer and the server. This would include taking the correct credit or debit card information for the consumer, processing the credit or debit card payment, and then paying the home chef(s) after deducting appropriate fees and costs.

The geographic locator 1016 functions like a GPS device in tracking the location of the customer interface device 104 from which the order was placed.

In addition, it is understood that each home chef need not provide the services for all four modules: order cooked food 130, order food for an event 132, order ingredients 134, and order packed food 136. Any home chef can choose to provide the services for any number of these modules.

Thus, the present invention provides a system and method where peers can interact with each other to facilitate the buying and selling of cooked and packaged food, as well as ingredients. The system of the present invention provides a busy consumer who seeks healthier food with a greater number of food choices. The system of the present invention also provides a home chef who aspires to share his or her special recipe(s) with a wider range of consumers who can actually sample the chef's wares. In addition, the system of the present invention allows any individual to be able to cook food for others and to sell food and ingredients without the need to invest in a brick-and-mortar restaurant or retail establishment.

The above detailed description is for the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices, components, mechanisms and methods are omitted so as to not obscure the description of the present invention with unnecessary detail.

What is claimed is:

1. A system for facilitating peer-to-peer provision of food services, comprising:
a plurality of home chefs who are human beings, each having a home chef interface device;
a plurality of consumers who are human beings, each having a consumer interface device; and
at least two of the following four modules:
a. an order cooked food module through which a consumer orders cooked food from a home chef for immediate consumption;
b. an order food for event module through which a consumer orders cooked food from a home chef for an event;
c. an order ingredients module through which a consumer orders ingredients from a home chef; and
d. an order packed food module through which a consumer orders packaged food items from a home chef.

2. The system of claim 1, further including a processor for processing the orders.

3. The system of claim 2, further including a communication module for facilitating communication between the processor and the various interface devices.

4. The system of claim 3, further including a chef database coupled to the processor that stores information about the plurality of home chefs.

5. The system of claim 4, further including a payment module coupled to the processor that processes the payment transaction for each order.

6. The system of claim 5, further including a delivery module coupled to the processor that processes the delivery for each order between a home chef and a consumer.

7. The system of claim 4, further including a consumer database coupled to the processor that stores information about the plurality of consumers.

8. The system of claim 6, further including a geographic locator that determines the location of the consumer's interface device.

9. The system of claim 1, wherein the system includes at least three of the following four modules:
a. an order cooked food module through which a consumer orders cooked food from a home chef for immediate consumption;
b. an order food for event module through which a consumer orders cooked food from a home chef for an event;
c. an order ingredients module through which a consumer orders ingredients from a home chef; and
d. an order packed food module through which a consumer orders packaged food items from a home chef.

10. The system of claim 1, wherein the system includes all of the following four modules:
a. an order cooked food module through which a consumer orders cooked food from a home chef for immediate consumption;
b. an order food for event module through which a consumer orders cooked food from a home chef for an event;
c. an order ingredients module through which a consumer orders ingredients from a home chef; and
d. an order packed food module through which a consumer orders packaged food items from a home chef.
